(19) United States
(12) Patent Application Publication
(10) Pub. No.: US 2014/0190179 A1
(43) Pub. Date: Jul. 10, 2014

(54) METHOD OF PRODUCING CARBON BLACK AND GENERATING ENERGY

(71) Applicants: Michael Owen Baker, Fergus (CA); Rodney Taylor, Wichita Falls, TX (US)

(72) Inventors: Michael Owen Baker, Fergus (CA); Rodney Taylor, Wichita Falls, TX (US)

(73) Assignee: Atlantic Hydrogen Inc., Fredericton (NB)

(21) Appl. No.: 14/114,412

(22) PCT Filed: Apr. 26, 2012
(86) PCT No.: PCT/US12/35226

§ 371 Date: Feb. 4, 2014

Related U.S. Application Data
(60) Provisional application No. 61/479,261, filed on Apr. 26, 2011.

(51) Int. Cl. C09C 1/48; F02C 3/22

(52) U.S. Cl. CPC C09C 1/48; F02C 3/22
USPC 60/780; 423/449.1; 423/458

(57) ABSTRACT

There is provided a process of producing carbon black and generating energy. The process includes converting a carbon black-yielding material supply into reaction product material. The reaction product material includes gaseous product material and solid particulate matter. The solid particulate matter includes carbon black. At least a fraction of the carbon black is recovered, and at least a fraction of the gaseous product material is combusted and used to effect generation of energy.

### FIELD

The present disclosure relates to a system and processes for producing carbon black.

### BACKGROUND

In the past, carbon black reactors have not been widely integrated with energy production technologies, so as to capture the energy value of gaseous products being exhausted from the reactor. It is desirable to efficiently integrate these technologies and produce a desirable carbon black product while generating energy.

### SUMMARY OF INVENTION

In one aspect, there is provided a process of producing carbon black and generating energy comprising: converting a carbon black-yielding material supply into reaction product material, wherein the reaction product material includes gaseous product material and solid particulate matter, wherein the solid particulate matter includes carbon black; treating a solid particulate matter-comprising intermediate supply material, including at least a fraction of the gaseous product material, so as to effect production of a solid particulate matter-depleted intermediate supply material, wherein the ratio of [mass of solid particulate matter within the solid particulate matter-depleted intermediate supply material] to [total mass of solid particulate matter-depleted intermediate supply material] is less than the ratio of [mass of the solid particulate matter within the solid particulate matter-comprising intermediate supply material] to [total mass of the solid particulate matter-comprising intermediate supply material]; supplying a fuel supply material, including at least a fraction of the solid particulate matter-depleted intermediate supply material, to a combustor; and combusting at least a fraction of the fuel supply material.

In another aspect, there is provided a process of producing carbon black and generating energy comprising: while converting at least a fraction of a carbon black-yielding supply material into reaction product material, wherein the reaction product material includes gaseous product material and solid particulate matter, wherein the solid particulate matter includes carbon black, and while supplying a fraction of the gaseous product material to a combustor for effecting combusting of at least a fraction of the gaseous product material, upon termination of the combusting, diverting the supply of the gaseous product material to another unit operation.

In another aspect, there is provided a process of producing carbon black and generating energy comprising: while converting at least a fraction of a carbon black-yielding supply material into reaction product material, wherein the reaction product material includes gaseous product material and solid particulate matter, wherein the solid particulate matter includes carbon black, and while supplying a fraction of the gaseous product material to a combustor for effecting combusting of at least a fraction of the gaseous product material for supplying of combustion products to a gas turbine, in response to sensing of an upset condition associated with the operation of the gas turbine, diverting the supply of the gaseous product material to another unit operation.

In yet another aspect, there is provided A process of producing carbon black and generating energy comprising: converting a carbon black-yielding supply material into reaction product material, wherein the reaction product material includes gaseous product material and carbon black, and the gaseous product material includes heavy hydrocarbon material, and the heavy hydrocarbon material is defined by at least one heavy hydrocarbon compound; treating a heavy hydrocarbon-comprising intermediate supply material that includes a gaseous heavy hydrocarbon-comprising intermediate supply material, so as to effect production of a heavy hydrocarbon-depleted intermediate supply material that includes a gaseous heavy hydrocarbon-depleted intermediate supply material, wherein the ratio of [moles of heavy hydrocarbon material within the gaseous heavy hydrocarbon-depleted intermediate supply material] to [total moles of the gaseous heavy hydrocarbon-depleted intermediate supply material] is less than the ratio of [moles of heavy hydrocarbon material within the gaseous heavy hydrocarbon-comprising intermediate supply material] to [total moles of the gaseous heavy hydrocarbon-comprising intermediate supply material]; supplying a fuel supply material, including at least a fraction of the heavy hydrocarbon-depleted intermediate supply material, to a combustor; and combusting at least a fraction of the fuel supply material; wherein the gaseous heavy hydrocarbon-comprising intermediate supply material includes at least a fraction of the gaseous product material.

In a further aspect, there is provided a process of producing carbon black and generating energy comprising: converting a carbon black-yielding supply material into reaction product material, wherein the reaction product material includes gaseous product material and carbon black, and the gaseous product material includes heavy hydrocarbon material, and the heavy hydrocarbon material is defined by at least one heavy hydrocarbon compound; cooling an intermediate supply material that includes a gaseous intermediate supply material, so as to effect condensation of, and thereby effect depletion of, heavier hydrocarbon material from the intermediate supply material, such that production of a heavy hydrocarbon-depleted intermediate supply material, that includes a gaseous heavy hydrocarbon-depleted intermediate supply material, is effected; supplying a fuel supply material, including at least a fraction of the heavy hydrocarbon-depleted intermediate supply material, to a combustor; and combusting at least a fraction of the fuel supply material; wherein the gaseous intermediate supply material includes at least a fraction of the gaseous product material.

In another aspect, there is provided a process of producing carbon black, comprising: converting a carbon black-yielding material supply into reaction product material within a reaction zone, wherein the reaction product material includes gaseous product material and solid particulate matter, wherein the solid particulate matter includes carbon black; effecting separation of a solid particulate material from a solid particulate matter-comprising intermediate supply material, such that production of a solid particulate matter-depleted intermediate supply material is effected, wherein the solid particulate matter-comprising intermediate supply material includes at least a fraction of the reaction product material; collecting the separated solid particulate matter-comprising product material within a collection space; and after the collecting of the solid particulate matter-comprising product material within the collection space, purging at least a fraction of flammable material entrained within or adhered to, the solid particulate matter-comprising product material, such that production of a flammable material-depleted solid particulate matter-comprising product material is effected.

In another aspect, there is provided a process for producing carbon black, comprising: converting a carbon black-yielding material supply into reaction product material, wherein the reaction product material includes gaseous product material and solid particulate matter, wherein the solid particulate material includes carbon black-comprising particulate material, and wherein the gaseous product material includes heavy hydrocarbon material; cooling a solid particulate matter-comprising intermediate supply material which includes at least a fraction of the reaction product material, such that at least a fraction of the heavy hydrocarbon material disposed within the gaseous product material is condensed and becomes entrained within, or adhered to, solid particulate material of the solid particulate matter-comprising intermediate supply material, such that production of a heavy hydrocarbon material-comprising solid particulate material is effected; and after the cooling, separating a solid particulate matter-comprising product material from the cooled solid particulate matter-comprising intermediate supply material, such that production of a solid particulate matter-depleted intermediate supply material is effected, wherein the solid particulate matter-comprising product material includes the heavy hydrocarbon material-comprising solid particulate material.

In another aspect, there is provided a process for producing carbon black and generating energy, comprising: while reactive processes are being effected within a reaction zone, wherein the reactive processes include effecting at least one of pyrolysis and partial oxidation of a gaseous carbon black-yielding material supply, such that production of a reaction product material is effected, wherein the reaction product material includes gaseous product material and carbon black-comprising particulate material; indirectly cooling reaction zone material disposed within the reaction zone so as to effect at least partial quenching of the reaction processes being effected within the reaction zone, wherein the reaction zone material includes the gaseous carbon black-yielding material supply and the reaction product material; combusting at least a fraction of the produced gaseous product material to effect production of a gaseous combustion product; and contacting a turbine with a gaseous combustion product flow so as to effect rotation of the turbine.

### DESCRIPTION OF DRAWINGS

The system and process of the preferred embodiments will now be described with the following accompanying drawings:

FIG. 1 is a process flow diagram of an embodiment of a system in which the process may be effected; and

FIG. 2 is a schematic illustration of a system for effecting collection and recovery of carbon black produced in the system illustrated in FIG. 1.

### DETAILED DESCRIPTION

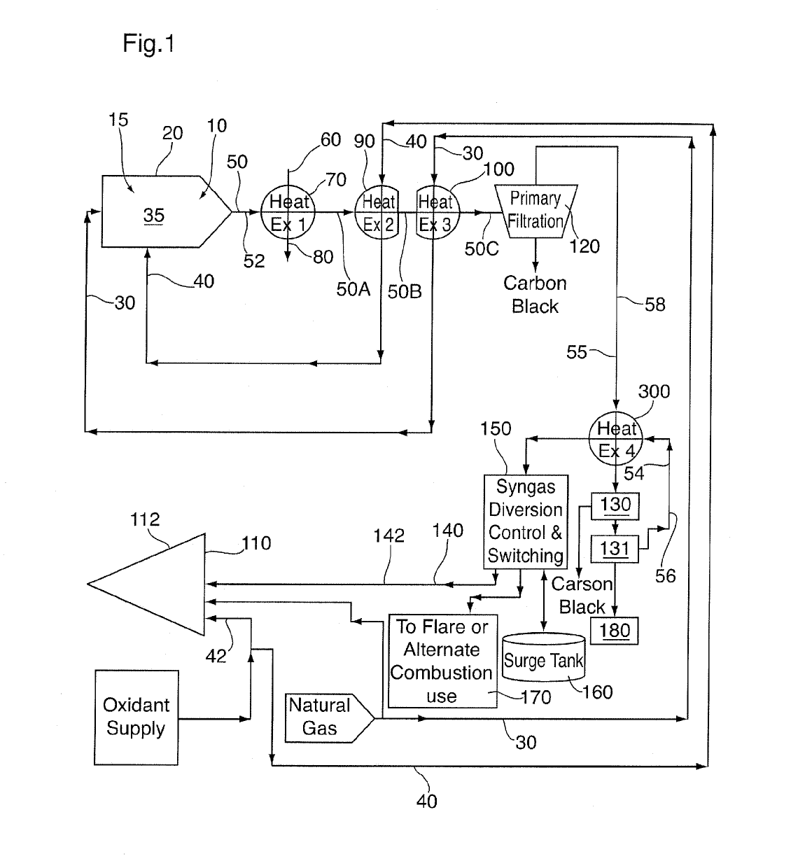

Referring to FIG. 1, there is provided a process of producing carbon black and energy.

The process includes, within a reaction zone 10, effecting at least partial conversion of a carbon black-yielding material supply into a reaction product material 50. The reaction product material 50 includes a carbon black-comprising particulate material and a gaseous product material 140. The gaseous product material 140 is a combustible gas and includes syngas (or “synthesis gas”). Syngas is a gaseous mixture that includes varying amounts of carbon monoxide and hydrogen. In some embodiments, for example, the reaction zone 10 is disposed within a reactor 20.

The carbon black-yielding material supply can be any material which, upon contacting with an operative transformation agent (which can be material, energy, or both material and energy), effects a reactive process which effects production of carbon black. In some embodiments, for example, the carbon black-yielding material supply includes one or more hydrocarbons. In some embodiments, for example, the carbon black-yielding material supply may be a liquid material, a gaseous material, or a mixture of a liquid material and a gaseous material. In some embodiments, for example, the carbon black-yielding material supply includes natural gas. In some embodiments for example, the carbon black-yielding material supply is natural gas. In some embodiments, for example, the carbon black-yielding material supply includes methane. In some embodiments for example, the carbon black-yielding material supply is methane.

The at least partial conversion is effected by at least one of partial oxidation and decomposition. In some embodiments, for example, the decomposition is effected by pyrolysis.

In some embodiments, for example, the at least partial conversion is effected at a temperature between 600 degrees Celsius and 2800 degrees Celsius. In some embodiments, for example, the at least partial conversion is effected at a temperature between 800 degrees Celsius and 2200 degrees Celsius. In some embodiments, for example, the at least partial conversion is effected at a temperature between 900 degrees Celsius and 1800 degrees Celsius.

In some embodiments, for example, the pressure within the reaction zone is between 0 and 55.4 atmospheres. In some embodiments, for example, the pressure within the reaction zone is between 1.14 atmospheres and 41.8 atmospheres. In some embodiments, for example, the pressure within the reaction zone is between 4.4 atmospheres and 21.4 atmospheres. In some embodiments, for example, the pressure within the reaction zone is about 7.8 atmospheres.

In some embodiments, for example, the partial conversion is effected by contacting the carbon black-yielding material supply with a gaseous combustion product in the reaction zone 10. In this respect, in some embodiments, for example, the operative transformation agent includes the gaseous combustion product. In some embodiments, for example, the gaseous combustion product is produced by effecting contact between a fuel material supply and an oxidant. The contacting effects, amongst other things, heating of the carbon black-yielding material supply to a temperature sufficient to effect decomposition of the carbon black-yielding material supply.

The fuel material supply is any material which, upon its combustion, effects production of energy. In some embodiments, for example, the fuel material supply is contacted with an oxidant within a combustion zone 15 of the reactor 20, and the combustion of the fuel material supply is effected, thereby effecting production of the gaseous combustion product. In some embodiments, for example, the contacting between the fuel material supply and the oxidant effects production of a pre-combustion reaction mixture, and the pre-combustion reaction mixture is ignited within the combustion zone 15 to effect production of the gaseous combustion product. In some embodiments, for example, the combustion of the fuel material supply is effected externally of the reactor 20, and the gaseous combustion product is then supplied to the reaction zone 10. The ignition can be effected by an artificial ignition source. After the process has been continuously operating for a sufficient period of time, glow from the refractory material of the reactor 20 may serve as the ignition source.

The fuel material supply may be a liquid material, or a gaseous material, or any combination thereof. In some embodiments, for example, the fuel material supply includes carbon-comprising material, such as one or more hydrocarbons. In some embodiments, for example, the fuel material supply includes natural gas, hydrogen, carbon monoxide, methane, acetylene, alcohol, LPG (liquefied propane gas), aromatic hydrocarbons, or any combination thereof.

Exemplary oxidants includes air, oxygen, and mixtures of air and oxygen.

In some embodiments, for example, the temperature of the gaseous combustion product is between 600 degrees Celsius and 2800 degrees Celsius. In some embodiments, for example, the temperature of the gaseous combustion product is between 800 degrees Celsius and 2200 degrees Celsius. In some embodiments, for example, the temperature of the gaseous combustion product is between 900 degrees Celsius and 1800 degrees Celsius.

In some embodiments, for example, either one of, or both of, the carbon black-yielding material supply and the fuel material supply includes methane.

In some embodiments, for example, either one of, or both of, the carbon black-yielding material supply and the fuel material supply includes natural gas.

In some embodiments, for example, the carbon black-yielding material supply includes the same material as the fuel material supply. In some embodiments, for example, the carbon black-yielding material supply derives from the same material as the fuel material supply.

In some embodiments, for example, the production of the gaseous combustion product, and the at least partial conversion of a carbon black-yielding material supply, is effected within the same reactor. It is understood that the combustion zone 15 and the reaction zone 10 need not be distinct physical sections of the reactor 20, and that portions of these zones 10, 15 may be co-located, if only intermittently. Reaction zone 10 and combustion zone 15 are, hereinafter, referred to as being “co-located”, if at least portions of these zones 10, 15 are co-located within the reactor 20, even if only intermittently.

In some embodiments, for example, the carbon black-yielding material supply and the fuel material supply are supplied as a combined hydrocarbon material supply 30 to co-located reaction and combustion zones 10, 15 such that a hydrocarbon reactant material is disposed within the co-located reaction and combustion zones 10, 15. The hydrocarbon reactant material is contacted with the oxidant to effect production of a carbon black-yielding reactant mixture, and the carbon black-yielding reactant mixture is ignited to effect production of the gaseous combustion product which, in turn, contacts the carbon black-yielding material supply to effect production of the reaction product material 50. In some embodiments, for example, the oxidant is supplied to co-located reaction and combustion zones 10, 15 by a reactor oxidant supply 40. In some embodiments, for example, the ratio of moles of carbon atoms to moles of oxygen atoms, within the carbon black-yielding reactant mixture, is greater than 0.5.

In some embodiments, for example, the carbon black-yielding material supply, the fuel material supply, and the oxidant are supplied as a carbon black-yielding reactant mixture supply to co-located reaction and combustion zones 10, 15 such that a carbon black-yielding reactant mixture is disposed within the co-located reaction and combustion zones 10, 15. The carbon black-yielding reactant mixture is reacted within the reaction zone to effect production of the gaseous combustion product which, in turn, contacts the carbon black-yielding material supply to effect production of the reaction product material 50. In some embodiments, for example, the ratio of moles of carbon atoms to moles of oxygen atoms, within the carbon black-yielding reactant mixture supply, is greater than 0.5. In this respect, in some embodiments, for example, the ratio of moles of carbon atoms to moles of oxygen atoms, within the carbon black-yielding reactant mixture, is greater than 0.5.

In some embodiments, for example, the carbon black-yielding material supply is supplied to the reaction zone 10 as a flow. In this respect, the at least partial conversion is effected while the carbon black-yielding material supply is being flowed through the reaction zone and being contacted with the operative transformation agent.

In some embodiments, for example, reaction zone material 35 is flowed through the reaction zone 10. The reaction zone material 35 includes unconverted carbon black-yielding material supply, the operative transformation agent (such as the gaseous combustion product), and any reaction product material 50 whose production has been effected by that portion of the carbon black-yielding material supply whose conversion has been effected within the reaction zone. The reaction zone material 35 may also include reagents configured to effect production of the operative transformation agent, such as, in those embodiments where the operative transformation agent is the gaseous combustion product, the fuel material supply and the oxidant. The composition of the reaction zone material 35 is variable throughout the reaction zone, owing to conversion that is effected by reactive processes effected within the reaction zone 10, including partial oxidation and/or pyrolytic decomposition of the carbon black-yielding material supply, and, in some embodiments, for example, combustion of the fuel material supply. The temperature within the reaction zone 10 is between 600 degrees Celsius and 2800 degrees Celsius. In some embodiments, for example, the temperature of the reaction zone 10 is between 800 degrees Celsius and 2200 degrees Celsius. In some embodiments, for example, the temperature of the reaction zone 10 is between 900 degrees Celsius and 1800 degrees Celsius.

The reaction zone material is the source from which is derived the reaction product material 50 that is discharged from the reaction zone 10.

In some embodiments, for example, the at least partial conversion of the carbon black-yielding material supply into the reaction product material 50 is effected by reactive processes that are effected within the reaction zone 10, and the reactive processes are quenched prior to the discharging of the reaction product material 50 from the reaction zone 10. The quenching includes effecting cooling (including direct or indirect cooling) of the reaction zone material 35 that is disposed within the reaction zone 10. In some embodiments, for example, the quenching is effected within the reactor 20.

In some embodiments, for example, the quenching effects a reduction in temperature of the reaction zone material 35 by at least 100 degrees Celsius.

In some embodiments, for example, the reaction zone material 35 is indirectly cooled with cooling water 60 in a heat exchanger 70. Heat is indirectly transferred from the reaction zone material 35 to the cooling water (for example, within a shell and tube heat exchanger) such that a first intermediate reaction product material 50A is produced. In some embodiments, for example, the heat absorbed by the cooling water is sufficient to effect production of steam 80 which is supplied for use directly as a source of heat or motive force for powering blowers or compressors or in another unit operation, such as a steam turbine for the production of electricity.

In some embodiments, for example, further heat is indirectly transferred from the first intermediate reaction product material 50A to the reactor oxidant supply 40 within a heat exchanger 90, so as to effect heating of the reactor oxidant supply 40 prior to supplying of the reactor oxidant supply 40 to the reaction zone 10. In some embodiments, for example, the reactor oxidant supply 40 is heated to a temperature of up to about 1000 degrees Celsius. The heat transfer effects cooling of the first intermediate reaction product material 50A such that production of a second intermediate cooled reaction product material 50B is effected.

In some embodiments, for example, further heat is indirectly transferred from the second intermediate cooled reaction product material 50B to the combined hydrocarbon material supply 30 within a heat exchanger 100, so as to effect heating of the combined hydrocarbon material supply prior to supplying of the combined hydrocarbon material supply to the co-located reaction and combustion zones. In some embodiments, for example, the combined hydrocarbon material 30 is heated to a temperature of up to about 400 degrees Celsius. The heat transfer effects cooling of the second intermediate cooled reaction product material such that production of a third intermediate cooled reaction product material 50C is effected.

At least a fraction of the gaseous product material 140, of the reaction product material 50, is supplied to a combustor, and the at least a fraction of the gaseous product material 140 is mixed with an oxidant supply 42 for the combustor (the “combustor oxidant supply 42”) to effect production of an operative reaction mixture, and the operative reaction mixture is then combusted to effect production of operative combustion product. In some embodiments, for example, the at least a fraction of the gaseous product material 140 is supplied to the combustor 110 at a pressure of between 4.4 atmospheres and 35 atmospheres. In some embodiments, for example, prior to the supplying of the at least a fraction of the gaseous product material 140 to the combustor, the at least a fraction of the gaseous product material is separated from the reaction product material 50. In some embodiments, for example, the separation is effected by mechanical filtration.

In some embodiments, for example, the operative combustion product is flowed, and the operative combustion product flow is contacted with a turbine to effect rotation of a turbine, such as the gas turbine 112. In some embodiments, for example, the combustor is disposed within a gas turbine 112.

In some embodiments, for example, a natural gas source 200 is fluidly coupled to the combustor 110 for supplying the combustor with fuel. In some of these embodiments, the natural gas source 200 is relied upon as a source of fuel for the combustor within the gas turbine 112 when fuel is not being supplied from the gaseous product mixture 140, or when there has been a reduction in the rate of fuel being supplied from the gaseous product mixture 140.

### First Aspect of Process

In one aspect, the process further includes treating a solid particulate matter-comprising intermediate supply material 52, wherein the solid particulate matter-comprising intermediate supply material 52 includes at least a fraction of the reaction product material 50 (and is derived from the reaction product material 50). In this respect, the solid particulate matter-comprising intermediate supply material 52 includes carbon black-comprising particulate material derived from the reaction product material 50, and also includes at least a fraction of the gaseous product material 140. The treating effects production of a solid particulate matter-depleted intermediate supply material 54. The solid particulate matter-depleted intermediate supply material 54 includes at least a fraction of the gaseous product material 140.

In some embodiments, for example, the treating includes separating a solid particulate matter-comprising product material from the solid particulate matter-comprising intermediate supply material 52, such that production of the solid particulate matter-depleted intermediate supply material 54 is effected. The solid particulate matter-comprising product material includes carbon black-comprising particulate material. The solid particulate matter-depleted intermediate supply material 54 includes at least a fraction of the gaseous product material 140. In some embodiments, for example, solid particulate matter-depleted intermediate supply material 54 may include minor amounts of particulate matter that has not been removed during the separation process that has effected the separation of the solid particulate matter-depleted intermediate supply material 54 from the reaction product material 50.

The separation can be effected, for example, by mechanical filtration, or electrostatic separation, or by cyclone separation.

In some embodiments, for example, the separation is effected by mechanical filtration. In this respect, in some embodiments, for example a mechanical filtration system is provided to effect the mechanical filtration. In some embodiments, for example, the mechanical filtration system includes one or more independent filtration units. In the illustrated embodiment, for example, the mechanical filtration system includes two separate mechanical filtration units 120, 130 disposed in series relative to one another. An example of a suitable mechanical filtration unit is a baghouse filter.

The ratio of [mass of solid particulate matter within the solid particulate matter-depleted intermediate supply material 54] to [total mass of solid particulate matter-depleted intermediate supply material 54] is less than the ratio of [mass of the solid particulate matter within the solid particulate matter-comprising intermediate supply material 52] to [total mass of the solid particulate matter-comprising intermediate supply material 52].

In some embodiments, for example, the ratio of [mass of solid particulate matter characterized by a particle size of less than five (5) microns, within the solid particulate matter-comprising intermediate supply material 52] to [total mass of solid particulate matter-comprising intermediate supply material 52] is greater than the ratio of [mass of solid particulate matter characterized by a particle size of less than five (5) microns, within the solid particulate matter-depleted intermediate supply material 54] to [total mass of solid particulate matter-depleted intermediate supply material 54] by a multiple of at least 1000.

A fuel supply material 142 is supplied to a combustor 110, wherein the fuel supply material includes at least a fraction of the solid particulate matter-depleted intermediate supply material 54. In this respect, the fuel supply material 142 includes at least a fraction of the gaseous product material 140 of the reaction product material 50. At least a fraction of the fuel supply material 142 is combusted with the combustor oxidant supply 42 to effect production of the operative combustion product.

In some embodiments, for example, the operative combustion product is flowed, and the operative combustion product flow is contacted with a turbine to effect rotation of the turbine, such as a gas turbine 112. In some embodiments, for example, the combustor is disposed within a gas turbine 112.

### Second Aspect of Process

In a second aspect, a separator, in communication with the reaction zone 10 that is disposed at a pressure between 1.14 atmospheres and 55.4 atmospheres, is provided to effect separation of a solid particulate matter-comprising product material from the solid particulate matter-comprising intermediate supply material 52, such that production of the solid particulate matter-depleted intermediate supply material 54 is effected. The solid particulate matter-comprising intermediate supply material 52 includes carbon black-comprising particulate material derived from the reaction product material 50, and also includes at least a fraction of the gaseous product material 140. The solid particulate material-depleted intermediate supply material 54 includes at least a fraction of the gaseous product material 140. In some embodiments, for example, solid particulate matter-depleted intermediate supply material 54 may include minor amounts of particulate matter that has not been removed during the separation process (for example, the mechanical filtration) that has effected the separation of the solid particulate matter-depleted intermediate supply material 54 from the reaction product material 50.

The separation can be effected, for example, by mechanical filtration, or electrostatic separation, or by cyclone separation.

In some embodiments, for example, the separation is effected by mechanical filtration using a mechanical filtration system. The mechanical filtration system includes one or more independent filtration units. The filtration system operates to effect recovery of the solid particulate matter-comprising product material, wherein the solid particulate matter-comprising product material includes relatively significant flammable gas content. Processing of the separated solid particulate matter-comprising product material, which includes the carbon black-comprising particulate material, into a useful form, includes purging of flammable material that is entrained within, or adhered (physically adhered or chemically bonded) to, the solid particulate matter-comprising product material. The flammable material includes a high calorific value—gaseous material. High calorific value—gaseous material means gaseous material including a calorific value of between 3,700 kilojoules per normal cubic metre and 37,000 kilojoules per normal cubic metre. The separated solid particulate matter-comprising product material is collected within a collection space, which is disposed in pressure communication with the reactor 12. After the collection of the solid particulate matter-comprising product material within the collection space, at least a fraction of flammable material entrained within or adhered to, the solid particulate matter-comprising product material is purged from the solid particulate matter-comprising product material, such that production of a flammable material-depleted solid particulate matter-comprising product material is effected. In some embodiments, for example, the purging is effected by a purge gas flow, such that the purging effects production of a flammable material-comprising purge gas. In some embodiments, for example, the flammable material-comprising purge gas is discharged in an environmentally-friendly manner, such as to a flare. In some embodiments, for example, the purge gas of the purge gas flow includes an inert gas. In some embodiments, for example, prior to the purging, the collection space is isolated from the reaction zone 10. Also, prior to the recovery of the flammable material-depleted solid particulate matter-comprising product material, fluid communication between the collection space and a lower pressure space (such as atmosphere), that is disposed at a lower pressure than the collection space, is effected, so as to effect a reduction of pressure within the collection space. In this respect, the collection space is vented to the lower pressure space. The lower pressure space can be, for example, a surge tank, hopper, or pipe spool. After the purging, and after the reduction in pressure within the collection space, the flammable material-depleted solid particulate matter-comprising product material is discharged (such as by gravity), and can then be further processed, such as by discharging the treated solid particulate matter-comprising product material to a conveyor for transport for further processing.

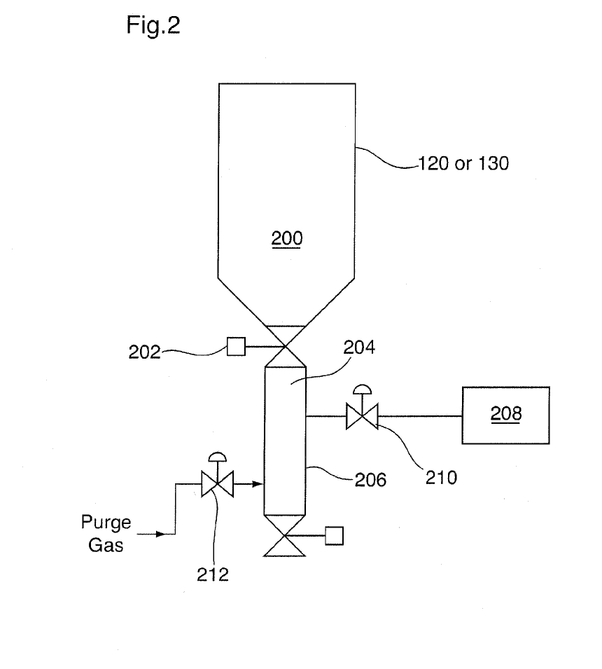

In some embodiments, for example, and referring to FIG. 2, the solid particulate matter-comprising product material is separated and collected within a receiving space 200 of either one of, or both of, the filtration units 120, 130. When receiving the solid particulate matter-comprising product material, the receiving space 200 is disposed in pressure communication with the reaction zone 10. When recovery of the collected solid particulate matter-comprising product material is desired, valve 202 is opened to permit the collected solid particulate matter-comprising product material to be discharged by gravity from the receiving space 200 into a treatment zone 204, defined within a spool piece 206. Once the collected solid particulate matter-comprising product material is disposed within the treatment zone 204, the valve 202 is closed, thereby isolating the collected solid particulate matter-comprising product material from the reaction zone 10. Once the collected solid particulate matter-comprising product material is isolated from the reaction zone 10, communication between the treatment zone 204 and a lower pressure space 208 is effected by opening previously closed valve 210. In some embodiments, for example, the lower pressure space 208 is defined by the suction side of a fan that is configured for supplying the gas to other combustion applications, such as a boiler or carbon dryer. The communication with the lower pressure space 208 effects a reduction in pressure within the treatment zone 204. In some embodiments, for example, the communication with the lower pressure space 208 effects pressure equalization between the treatment zone 204 and the lower pressure space 204. After the communication between the treatment zone 204 and the lower pressure space 208 is effected, and while the valve 210 is open, previously closed valve 212 is opened, and a purge gas is flowed through the treatment zone 204, for effecting removal of any flammable material that is entrained within, or adhered to, the collected solid particulate matter-comprising product material, such that production of a flammable material-comprising purge gas is effected. A screening device or filter is disposed within the spool piece 206 to contain the collected solid particulate matter-comprising product material within the treatment zone 204, including during the purging. In some embodiments, for example, the flammable material-comprising purge gas is discharged in an environmentally-friendly manner, such as to a flare. The purge gas is an inert gas (such as carbon dioxide or nitrogen, or a mixture thereof). After the flowing purge gas has effected sufficient removal of the flammable material from the collected solid particulate matter-comprising product material so as to effect production of the flammable material-depleted solid particulate matter-comprising product material, the valve 212 is closed, and valve 210 remains open in order to establish atmospheric conditions within the treatment zone 204 prior to recovering the flammable material-depleted solid particulate matter-comprising product material. After atmospheric conditions have been established within the treatment zone 204, a previously closed valve 214 is opened to effect discharge of the flammable material-depleted solid particulate matter-comprising product material by gravity. After the flammable material-depleted solid particulate matter-comprising product material has been recovered, the valves 210 and 214 are closed, so as to facilitate recovery of newly produced and collected solid particulate matter-comprising product material.

A fuel supply material 142 is supplied to a combustor 110, wherein the fuel supply material includes at least a fraction of the solid particulate matter-depleted intermediate supply material 54. In this respect, the fuel supply material 142 includes at least a fraction of the gaseous product material 140 of the reaction product material 50. At least a fraction of the fuel supply material 142 is combusted with the combustor oxidant supply 42 to effect production of the operative combustion product.

In some embodiments, for example, the operative combustion product is flowed, and the operative combustion product flow is contacted with a turbine to effect rotation of the turbine, such as a gas turbine 112. In some embodiments, for example, the combustor is disposed within a gas turbine 112.

### Third Aspect of Process

A third aspect provides another process of producing carbon black and generating energy. While converting at least a fraction of a carbon black-yielding supply material into the reaction product material 50, wherein the reaction product material 50 includes the carbon black-comprising product material and the gaseous product material 140, supplying at least a fraction of the gaseous product material 140 to a combustor 110 to effect combusting of at least a fraction of the gaseous product material 140, upon, or in response to, suspension or termination of the combusting, diverting the supply of the gaseous product material 140 to another unit operation.

In some embodiments, for example, the combusting effects production of an operative combustion product, and the operative combustion product is flowed, and the flowing of the operative combustion product effects rotation of a turbine of the gas turbine 112. In some of these embodiments, the combusting is effected within a gas turbine 112. In some of these embodiments, the suspension or termination of the combusting is effected in response to an upset condition associated with operation of the turbine, such as insufficient lubrication (eg. of bearings) which is sensed or detected, for example, with an lubricant oil pressure sensor, or with a lubricant oil flow sensor, or by high vibration sensor, or other sensors which are configured to sense or detect other mechanical failures or instabilities. In this respect, in a related aspect, the diverting is effected in response to the sensing of an upset condition associated with the operation of the turbine.

In some embodiments, for example, suitable control mechanisms 150 are provided to divert the gaseous product material 140 (including the syngas) from supply to the combustor.

In some embodiments, for example, the another unit operation includes a surge tank 160.

In some embodiments, for example, the another unit operation includes a flare 170.

### Fourth Aspect of Process

In a fourth aspect, the gaseous product material 140 of the reaction product material 50 includes heavy hydrocarbon material, and the heavy hydrocarbon material is defined by at least one heavy hydrocarbon compound. In this context, a heavy hydrocarbon compound is a hydrocarbon compound that is a liquid at a temperature of 148 degrees Celsius and 1.14 atmospheres.

A heavy hydrocarbon-comprising intermediate supply material 55 is treated. The heavy hydrocarbon-comprising intermediate supply material 55 includes a gaseous heavy hydrocarbon-comprising intermediate supply material. The gaseous heavy hydrocarbon-comprising intermediate supply material includes at least a fraction of the gaseous product material 140, and includes at least a fraction of the heavy hydrocarbon material of the gaseous product material 140. In this respect, the gaseous heavy hydrocarbon-comprising intermediate supply material includes heavy hydrocarbon material. In some embodiments, for example, the heavy hydrocarbon-comprising intermediate supply material 55 includes the solid particulate matter-depleted intermediate supply material 54 (which includes at least a fraction of the gaseous product material 140) that has been separated from the reaction product material 50 (for example, by mechanical filtration, such as by filtration units 120, 130). In some embodiments, for example, the heavy hydrocarbon-comprising intermediate supply material 55 may include minor amounts of particulate matter that has not been removed during the filtration that has effected the separation of the solid particulate matter-depleted intermediate supply material 54 from the reaction product material 50.

The treatment effects production of a heavy hydrocarbon-depleted intermediate supply material 56, which includes a gaseous heavy hydrocarbon-depleted intermediate supply material 56, wherein the ratio of [moles of heavy hydrocarbon material within the gaseous heavy hydrocarbon-depleted intermediate supply material] to [total moles of the gaseous heavy hydrocarbon-depleted intermediate supply material] is less than the ratio of [moles of gaseous heavy hydrocarbon material within the gaseous heavy hydrocarbon-comprising intermediate supply material] to [total moles of the gaseous heavy hydrocarbon-comprising intermediate supply material].

In some embodiments, for example, the ratio of [moles of heavy hydrocarbon material, within the gaseous heavy hydrocarbon-comprising intermediate supply material,] to [total moles of the gaseous heavy hydrocarbon-comprising intermediate supply material] is greater than the ratio of [moles of heavy hydrocarbon material, within the gaseous heavy hydrocarbon-depleted intermediate supply material] to [total moles of the gaseous heavy hydrocarbon-depleted intermediate supply material] by a multiple of at least ten (10).

In some embodiments, for example, the treating includes, from the heavy hydrocarbon-comprising intermediate supply material 55, separating the heavy hydrocarbon-depleted intermediate supply material 56 and a heavy hydrocarbon product material 180, such that the heavy hydrocarbon-depleted intermediate supply material 56 is separated from the heavy hydrocarbon product material 180. In some of these embodiments, for example, the separation is effected by condensation. In some embodiments, for example, the separation is effected by cooling the heavy hydrocarbon-comprising intermediate supply material 55 so as to effect condensation of at least a fraction of the heavy hydrocarbon material from the gaseous heavy hydrocarbon-comprising intermediate supply material so as to effect production of a liquid heavy hydrocarbon material-entrained heavy hydrocarbon-comprising intermediate supply material, and then effecting separation of at least a fraction of the entrained liquid heavy hydrocarbon material from the liquid heavy hydrocarbon material-entrained heavy hydrocarbon-comprising intermediate supply material within a coalescing filter 131 such that production of the heavy hydrocarbon-depleted intermediate supply material 56 is effected.

In this aspect, the fuel supply material 142 includes at least a fraction of the heavy hydrocarbon-depleted intermediate supply material 56. In this respect, the fuel supply material 142 includes at least a fraction of the gaseous product material 140 of the reaction product material 50. The fuel supply material 142 is supplied to a combustor 110, and at least a fraction of the fuel supply material is combusted within the combustor with the combustor oxidant supply to effect production of an operative combustion product.

In some embodiments, for example, the operative combustion product is flowed, and the operative combustion product flow is contacted with a turbine to effect rotation of the turbine, such as a gas turbine 112. In some embodiments, for example, the combustor is disposed within a gas turbine 112.

### Fifth Aspect of Process

In a fifth aspect, an intermediate supply material 58, including a gaseous intermediate supply material, is provided. The gaseous intermediate supply material includes at least a fraction of the gaseous product material 140. In this respect, the gaseous intermediate supply material includes at least a fraction of the heavy hydrocarbon material of the gaseous product material 140. In some embodiments, for example, the intermediate supply material 58 includes the solid particulate matter-depleted intermediate supply material 54 (which includes at least a fraction of the gaseous product material 140) that has been separated from the reaction product material 50 (for example, by mechanical filtration, such as by filtration units 120, 130). In some embodiments, for example, the intermediate supply material 58 may include minor amounts of particulate matter that has not been removed during the filtration that has effected the separation of the solid particulate matter-depleted intermediate supply material 54 from the reaction product material 50.

Heavy hydrocarbon material is separated from the intermediate supply material 56 to effect production of a heavy hydrocarbon-depleted intermediate supply material. The heavy hydrocarbon material is defined by at least one heavy hydrocarbon compound. A heavy hydrocarbon compound is a hydrocarbon compound that is a liquid at a temperature of 300 degrees Fahrenheit and 2 psig.

The intermediate supply material 58 is cooled, so as to effect condensation of heavy hydrocarbon material from the gaseous intermediate supply material. The condensed heavy hydrocarbon material is separated from the intermediate supply material 58 so as to effect production of the heavy hydrocarbon-depleted intermediate supply material 56.

The heavy hydrocarbon-depleted intermediate supply material 56 is heated prior to being supplied to the combustor 110. In some embodiments, for example, the heavy hydrocarbon-depleted intermediate supply material 56 is indirectly heated within heat exchanger 300, by the intermediate supply material 58, prior to the separating of the heavy hydrocarbon material. In some embodiments, for example, this heating mitigates against condensation of heavier hydrocarbons, from the heavy hydrocarbon-depleted intermediate supply material 56 prior to its supply to the combustor 110. Such condensed heavier hydrocarbons, when entrained within a combustion product produced by the combustor 110, could damage rotating mechanical equipment, such as a turbine, upon contacting of the combustion product with such rotating mechanical equipment.

In this aspect, the fuel supply material 142 includes at least a fraction of the heavy hydrocarbon-depleted intermediate supply material 56. In this respect, the fuel supply material includes at least a fraction of the gaseous product material 140 of the reaction product material 50. The fuel supply material 142 is supplied to a combustor 110, and at least a fraction of the fuel supply material is combusted within the combustor with the combustor oxidant supply 42 so as to effect production of the operative combustion product.

In some embodiments, for example, the operative combustion product is flowed, and the operative combustion product flow is contacted with a turbine to effect rotation of the turbine, such as a gas turbine 112. In some embodiments, for example, the combustor is disposed within a gas turbine 112.

### Sixth Aspect of Process

In some embodiments, for example, prior to the separating of the solid particulate matter-comprising product material from the solid particulate matter-comprising intermediate supply material 52, cooling of the solid particulate matter-comprising intermediate supply material 52 is effected such that heavy hydrocarbon material, that is derived from the gaseous product material 140, and is present within the solid particulate matter-comprising intermediate supply material 52, is condensed and becomes entrained within, or adhered to, solid particulate matter of the solid particulate matter-comprising intermediate supply material 52 (which includes carbon black-comprising particulate material), such that production of a heavy hydrocarbon material-comprising solid particulate material is effected.

In some embodiments, for example, the cooling is such that the temperature of the solid particulate matter-comprising intermediate supply material 52 is less than 500 degrees Fahrenheit. In some embodiments, for example, the cooling is such that the temperature of the solid particulate matter-comprising intermediate supply material 52 is less than 350 degrees Fahrenheit. the cooling is such that the temperature of the solid particulate matter-comprising intermediate supply material 52 is about 300 degrees Fahrenheit.

After the cooling, the solid particulate matter-comprising product material is separated from the solid particulate matter-comprising intermediate supply material 52, such that production of the solid particulate matter-depleted intermediate supply material 54 is effected. The solid particulate matter-comprising product material includes the heavy hydrocarbon material-comprising solid particulate material. In some embodiments, for example, the separation is effected by mechanical filtration, such as by mechanical filtration by filtration units 120, 130.

The fuel supply material 142 is supplied to a combustor 110, wherein the fuel supply material includes at least a fraction of the solid particulate matter-depleted intermediate supply material 54. The solid particulate matter-depleted intermediate supply material 54 includes at least a fraction of the gaseous product material 140. In some embodiments, for example, solid particulate matter-depleted intermediate supply material 54 may include minor amounts of particulate matter that has not been removed during the separation process that has effected the separation of the solid particulate matter-depleted intermediate supply material 54 from the reaction product material 50. In this respect, the fuel supply material 142 includes at least a fraction of the gaseous product material 140 of the reaction product material 50. At least a fraction of the fuel supply material 142 is combusted with the combustor oxidant supply 42 to effect production of the operative combustion product.

In some embodiments, for example, the operative combustion product is flowed, and the operative combustion product flow is contacted with a turbine to effect rotation of the turbine, such as a gas turbine 112. In some embodiments, for example, the combustor is disposed within a gas turbine 112.

Although it is undesirable to effect production of carbon black particulate material that includes excessive amounts of entrained hydrocarbons, some entrainment is tolerable. Further, the entrainment of heavy hydrocarbon material within (or the adherence of the heavy hydrocarbon material to) the produced carbon black particulate material mitigates against the condensation of heavy hydrocarbon material in the fuel supply material that is supplied to the combustor and is then used to effect rotation of a turbine, which mitigates the risk of damage caused to the turbine by any condensed heavy hydrocarbon material.

### Seventh Aspect of Process

In another aspect, while reactive processes are being effected within the reaction zone 10, wherein the reactive processes include effecting at least one of pyrolysis and partial oxidation of the gaseous carbon black-yielding material supply, such that production of the reaction product material 50 is effected, wherein the reaction product material 50 includes gaseous product material 140 and carbon black-comprising particulate material, the reaction zone material 35 within the reaction zone 10 is indirectly cooled so as to effect at least partial quenching of the reaction processes being effected within the reaction zone 10. The reaction zone material 35 includes the gaseous carbon black-yielding material supply and the reaction product material. At least a fraction of the produced gaseous product material 140 is supplied to the combustor 110 and combusted so as to effect production of a gaseous combustion product. A flow of the gaseous combustion product is contacted with a turbine so as to effect rotation of the turbine. In some embodiments, for example, the turbine is a gas turbine 112.

In some embodiments, for example, the indirect cooling effects a decrease in temperature of the reaction zone material 35 disposed within the reaction zone 10 by at least 100 degrees Celsius.

The indirect cooling includes effecting indirect heat transfer from the reaction zone material 35 to a cooling fluid. In some embodiments, for example, the cooling fluid is water, and the indirect cooling is effected within a quench boiler 60 so as to effect production of steam. In some embodiments, for example, the produced steam is used directly as a source of heat or motive force for powering blowers or compressors or in another unit operation, such as a steam turbine for the production of electricity.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

1. A process of producing carbon black and generating energy comprising:
converting a carbon black-yielding material supply into reaction product material, wherein the reaction product material includes gaseous product material and solid particulate matter, wherein the solid particulate matter includes carbon black;
treating a solid particulate matter-comprising intermediate supply material, including at least a fraction of the gaseous product material, so as to effect production of a solid particulate matter-depleted intermediate supply material, wherein the ratio of [mass of solid particulate matter within the solid particulate matter-depleted intermediate supply material] to [total mass of solid particulate matter-depleted intermediate supply material] is less than the ratio of [mass of the solid particulate matter within the solid particulate matter-comprising intermediate supply material] to [total mass of the solid particulate matter-comprising intermediate supply material];
supplying a fuel supply material, including at least a fraction of the solid particulate matter-depleted intermediate supply material, to a combustor; and
combusting at least a fraction of the fuel supply material.

2. The process as claimed in claim 1;
wherein the treating includes separating a solid particulate matter-comprising product material from the solid particulate matter-comprising intermediate supply material, such that production of the solid particulate matter-depleted intermediate supply material is effected.

3. The process as claimed in claim 2;
wherein the separation is effected by mechanical filtration.

4. The process as claimed in claim 1;
wherein the ratio of [mass of solid particulate matter characterized by a particle size of less than five (5) microns, within the solid particulate matter-comprising intermediate supply material,] to [total mass of solid particulate matter-comprising intermediate supply material] is greater than the ratio of [mass of solid particulate matter characterized by a particle size of less than five (5) microns, within the solid particulate matter-depleted intermediate supply material] to [total mass of solid particulate matter-depleted intermediate supply material] by a multiple of at least 1000.

5. The process as claimed in claim 1;
wherein the fuel supply material includes synthesis gas of the gaseous product material into which the carbon black-yielding material is converted.

6. The process as claimed in claim 1;
wherein the carbon black-yielding material includes hydrocarbon materials;
and wherein the ratio of moles of carbon atoms to moles of oxygen atoms, within the carbon black-yielding material supply, is greater than 0.5.

7. The process as claimed in claim 6;
wherein the hydrocarbon materials include methane.

8. The process as claimed in claim 6;
wherein the hydrocarbon materials include natural gas.

9. The process as claimed in claim 1;
wherein the combusting effects production of an operative combustion product, and a turbine is contacted by a flow of the operative combustion product rotation so as to effect rotation of the turbine.

10. A process of producing carbon black and generating energy comprising:
while converting at least a fraction of a carbon black-yielding supply material into reaction product material, wherein the reaction product material includes gaseous product material and solid particulate matter, wherein the solid particulate matter includes carbon black, and while supplying a fraction of the gaseous product material to a combustor for effecting combusting of at least a fraction of the gaseous product material, upon termination of the combusting, diverting the supply of the gaseous product material to another unit operation.

11. The process as claimed in claim 10;
wherein the another unit operation includes a surge tank.

12. The process as claimed in claim 10;
wherein the another unit operation includes a flare.

13. The process as claimed in claim 10;
wherein the combusting effects production of an operative combustion product, and a turbine is contacted by a flow of the operative combustion product rotation so as to effect rotation of the turbine.

14. A process of producing carbon black and generating energy comprising:
while converting at least a fraction of a carbon black-yielding supply material into reaction product material, wherein the reaction product material includes gaseous product material and solid particulate matter, wherein the solid particulate matter includes carbon black, and while supplying a fraction of the gaseous product material to a combustor for effecting combusting of at least a fraction of the gaseous product material for supplying of combustion products to a gas turbine, in response to sensing of an upset condition associated with the operation of the gas turbine, diverting the supply of the gaseous product material to another unit operation.

15. The process as claimed in claim 14;
wherein the another unit operation includes a surge tank.

16. The process as claimed in claim 14;
wherein the another unit operation includes a flare.

17. The process as claimed in claim 14;
wherein the combusting effects production of an operative combustion product, and a turbine is contacted by a flow of the operative combustion product rotation so as to effect rotation of the turbine.

18. A process of producing carbon black and generating energy comprising:
converting a carbon black-yielding supply material into reaction product material, wherein the reaction product material includes gaseous product material and carbon black, and the gaseous product material includes heavy hydrocarbon material, and the heavy hydrocarbon material is defined by at least one heavy hydrocarbon compound;
treating a heavy hydrocarbon-comprising intermediate supply material that includes a gaseous heavy hydrocarbon-comprising intermediate supply material, so as to effect production of a heavy hydrocarbon-depleted intermediate supply material that includes a gaseous heavy hydrocarbon-depleted intermediate supply material, wherein the ratio of [moles of heavy hydrocarbon material within the gaseous heavy hydrocarbon-depleted intermediate supply material] to [total moles of the gaseous heavy hydrocarbon-depleted intermediate supply material] is less than the ratio of [moles of heavy hydrocarbon material within the gaseous heavy hydrocarbon-comprising intermediate supply material] to [total moles of the gaseous heavy hydrocarbon-comprising intermediate supply material];
supplying a fuel supply material, including at least a fraction of the heavy hydrocarbon-depleted intermediate supply material, to a combustor; and
combusting at least a fraction of the fuel supply material;
wherein the gaseous heavy hydrocarbon-comprising intermediate supply material includes at least a fraction of the gaseous product material.

19. The process as claimed in claim 18;
wherein the treating includes, from the heavy hydrocarbon-comprising intermediate supply material, separating the heavy hydrocarbon-depleted intermediate supply material and a heavy hydrocarbon product material.

20. The process as claimed in claim 19;
wherein the separation is effected by condensation.

21. The process as claimed in claim 18;
wherein the ratio of [moles of heavy hydrocarbon material, within the gaseous heavy hydrocarbon-comprising intermediate supply material,] to [total moles of the gaseous heavy hydrocarbon-comprising intermediate supply material] is greater than the ratio of [moles of heavy hydrocarbon material, within the gaseous heavy hydrocarbon-depleted intermediate supply material] to [total moles of the gaseous heavy hydrocarbon-depleted intermediate supply material] by a multiple of at least ten (10).

22. The process as claimed in claim 18;
wherein the fuel supply material includes synthesis gas of the gaseous product material into which the carbon black-yielding material is converted.

23. The process as claimed in claim 18;
wherein the carbon black-yielding material includes hydrocarbon materials;
and wherein the ratio of moles of carbon atoms to moles of oxygen atoms, within the carbon black-yielding material supply, is greater than 0.5.

24. The process as claimed in claim 23;
wherein the hydrocarbon materials include methane.

25. The process as claimed in claim 23;
wherein the hydrocarbon materials include natural gas.

26. The process as claimed in claim 18;
wherein the combusting effects production of an operative combustion product, and a turbine is contacted by a flow of the operative combustion product rotation so as to effect rotation of the turbine.

27. A process of producing carbon black and generating energy comprising:
converting a carbon black-yielding supply material into reaction product material, wherein the reaction product material includes gaseous product material and carbon black, and the gaseous product material includes heavy hydrocarbon material, and the heavy hydrocarbon material is defined by at least one heavy hydrocarbon compound;
cooling an intermediate supply material that includes a gaseous intermediate supply material, so as to effect condensation of, and thereby effect depletion of, heavier hydrocarbon material from the intermediate supply material, such that production of a heavy hydrocarbon-depleted intermediate supply material, that includes a gaseous heavy hydrocarbon-depleted intermediate supply material, is effected;
supplying a fuel supply material, including at least a fraction of the heavy hydrocarbon-depleted intermediate supply material, to a combustor; and
combusting at least a fraction of the fuel supply material;
wherein the gaseous intermediate supply material includes at least a fraction of the gaseous product material.

28. The process as claimed in claim 27;
wherein the fuel supply material includes the synthesis gas of the gaseous product material into which the carbon black-yielding material is converted.

29. The process as claimed in claim 27;
wherein the carbon black-yielding material includes hydrocarbon materials;
and wherein the ratio of moles of carbon atoms to moles of oxygen atoms, within the carbon black-yielding material supply, is greater than 0.5.

30. The process as claimed in claim 29;
wherein the hydrocarbon materials include methane.

31. The process as claimed in claim 29;
wherein the hydrocarbon materials include natural gas.

32. The process as claimed in claim 27;
wherein the combusting effects production of an operative combustion product, and a turbine is contacted by a flow of the operative combustion product rotation so as to effect rotation of the turbine.

33. The process as claimed in claim 27;
wherein the heavy hydrocarbon-depleted intermediate supply material is heated prior to being supplied to the combustor.

34. A process of producing carbon black, comprising:
converting a carbon black-yielding material supply into reaction product material within a reaction zone, wherein the reaction product material includes gaseous product material and solid particulate matter, wherein the solid particulate matter includes carbon black;
effecting separation of a solid particulate material from a solid particulate matter-comprising intermediate supply material, such that production of a solid particulate matter-depleted intermediate supply material is effected, wherein the solid particulate matter-comprising intermediate supply material includes at least a fraction of the reaction product material;
collecting the separated solid particulate matter-comprising product material within a collection space; and
after the collecting of the solid particulate matter-comprising product material within the collection space, purging at least a fraction of flammable material entrained within or adhered to, the solid particulate matter-comprising product material, such that production of a flammable material-depleted solid particulate matter-comprising product material is effected.

35. The process as claimed in claim 34;
wherein the purging is effected by a purge gas flow, such that the purging effects production of a flammable material-comprising purge gas.

36. The process as claimed in claim 35;
wherein the purge gas of the purge gas flow includes an inert gas.

37. The process as claimed in claim 34;
wherein, prior to the purging, the collection space is isolated from the reaction zone.

38. The process as claimed in claim 35;
wherein the reaction zone is disposed at a pressure of greater than 1.14 atmospheres;
and wherein, prior to the purging, the collection space is isolated from the reaction zone.

39. The process as claimed in claim 38;
wherein, prior to recovery of the flammable material-depleted solid particulate matter-comprising product material, fluid communication between the collection space and a lower pressure space, that is disposed at a lower pressure than the collection space, is effected, so as to effect a reduction of pressure within the collection space;
and further comprising, after the effecting of a reduction of pressure within the collection space, recovering the flammable material-depleted solid particulate matter-comprising product material.

40. The process as claimed in claim 39;
wherein the lower pressure space is disposed at atmospheric pressure, and the recovering of the flammable material-depleted solid particulate matter-comprising product material is effecting by gravity discharge from the collection space.

41. The process as claimed in any one of claims 40 to 41;
wherein the flammable material includes high calorific value- gaseous material.

42. The process as claimed in claim 41;
wherein the carbon black-yielding material supply includes methane.

43. A process for producing carbon black, comprising:
converting a carbon black-yielding material supply into reaction product material, wherein the reaction product material includes gaseous product material and solid particulate matter, wherein the solid particulate material includes carbon black-comprising particulate material, and wherein the gaseous product material includes heavy hydrocarbon material;
cooling a solid particulate matter-comprising intermediate supply material which includes at least a fraction of the reaction product material, such that at least a fraction of the heavy hydrocarbon material disposed within the gaseous product material is condensed and becomes entrained within, or adhered to, solid particulate material of the solid particulate matter-comprising intermediate supply material, such that production of a heavy hydrocarbon material-comprising solid particulate material is effected; and
after the cooling, separating a solid particulate matter-comprising product material from the cooled solid particulate matter-comprising intermediate supply material, such that production of a solid particulate matter-depleted intermediate supply material is effected, wherein the solid particulate matter-comprising product material includes the heavy hydrocarbon material-comprising solid particulate material.

44. The process as claimed in claim 43;
wherein the separation is effected by mechanical filtration.

45. The process as claimed in claim 43;
wherein the cooling is such that the temperature of the solid particulate matter-comprising intermediate supply material is less than 260 degrees Celsius.

46. The process as claimed in claim 43;
further comprising supplying fuel supply material to a combustor, wherein the fuel supply material includes at least a fraction of the solid particulate matter-depleted intermediate supply material.

47. The process as claimed in claim 46;
further comprising combusting at least a fraction of the fuel supply material to effect production of an operative combustion product.

48. The process as claimed in claim 47;
further comprising contacting a turbine with a gaseous combustion product flow so as to effect rotation of the turbine.

49. A process for producing carbon black and generating energy, comprising:
while reactive processes are being effected within a reaction zone, wherein the reactive processes include effecting at least one of pyrolysis and partial oxidation of a gaseous carbon black-yielding material supply, such that production of a reaction product material is effected, wherein the reaction product material includes gaseous product material and carbon black-comprising particulate material;
indirectly cooling reaction zone material disposed within the reaction zone so as to effect at least partial quenching of the reaction processes being effected within the reaction zone, wherein the reaction zone material includes the gaseous carbon black-yielding material supply and the reaction product material;
combusting at least a fraction of the produced gaseous product material to effect production of a gaseous combustion product; and
contacting a turbine with a gaseous combustion product flow so as to effect rotation of the turbine.

50. The process as claimed in claim 49;
wherein the indirect cooling effects a decrease in temperature of the reaction zone material by at least 100 degrees Celsius.

51. The process as claimed in claim 49 or 50;
wherein reaction zone material is disposed within the reaction zone, and wherein the reaction zone material includes the gaseous carbon black-yielding material supply and the reaction product material, and wherein the indirect cooling includes effecting indirect heat transfer from the reaction zone material to a cooling fluid.

52. The process as claimed in claim 51
wherein the cooling fluid is water, and wherein the indirect cooling is effected within a quench boiler.

53. The process as claimed in claim 49;
wherein the indirect cooling is effected within a quench boiler.
